(19) United States
(12) Patent Application Publication
(10) Pub. No.: US 2026/0124981 A1
(43) Pub. Date: May 7, 2026

(54) STORAGE TANK MOUNTING FOR HYBRID MINING TRUCKS

(71) Applicant: Cummins Inc., Columbus, IN (US)

(72) Inventor: Kieran J. Richards, Northamptonshire (GB)

(21) Appl. No.: 18/934,976

(22) Filed: Nov. 1, 2024

(51) Int. Cl. B60P 3/22

(52) U.S. Cl. CPC B60P 3/222

(57) ABSTRACT

A support structure for a mining truck can include an interior mounting interface. The interior mounting interface can be configured to removably attach the support structure to a chassis of the mining truck. The support structure can further include a center mounting interface. The center mounting interface can be configured to support an interior storage tank adjacent to the chassis. The support structure can further include an exterior mounting interface. The exterior mounting interface can be configured to support an exterior storage tank adjacent to the interior storage tank.

### TECHNICAL FIELD OF THE PRESENT DISCLOSURE

The present disclosure relates to architectures, or component arrangement, of hybrid mining trucks. In particular, the present disclosure relates to mounting storage tanks to a hybrid mining truck.

### BACKGROUND OF THE PRESENT DISCLOSURE

Environmental and efficiency considerations have resulted in the electrification of vehicles across industries and purposes. While electric and hybrid passenger and cargo vehicles are becoming more commonplace, electrification and/or hybridization of large equipment vehicles poses its own set of challenges. For example, large equipment vehicles, such as mining trucks, cranes, bulldozers, etc., may require a workload and/or have a sheer size component that makes implementation of alternative powertrains more difficult. Additionally, the components required for hybridization and/or electrification of such vehicles may be difficult to arrange due to the space available relative to the respective vehicle for mounting such components.

### SUMMARY OF THE DISCLOSURE

The present disclosure provides a support structure for a mining truck. The support structure includes an interior mounting interface configured to removably attach the support structure to a chassis of the mining truck; a center mounting interface configured to support an interior storage tank adjacent to the chassis; and an exterior mounting interface configured to support an exterior storage tank adjacent to the interior storage tank. In another embodiment, the interior mounting interface includes an interior pivot axis about which the support structure is pivotable relative to the chassis. The center mounting interface includes a center pivot axis about which the interior storage tank is pivotable relative to the support structure; and the exterior mounting interface includes an exterior pivot axis about which the exterior storage tank is pivotable relative to the support structure. Further, each of the interior mounting interface, the center mounting interface, and the exterior mounting interface is pivotable independently of each other. In another embodiment, each of the interior mounting interface, the center mounting interface, and the exterior mounting interface includes a damping portion having one or more vibration dampers.

In yet another embodiment, the support structure includes an upper beam extending between the interior mounting interface and the exterior mounting interface. The upper beam includes a channel having a first end and a second end; the interior mounting interface includes an interior bar member attached to the first end; and the exterior mounting interface includes an exterior bar member attached to the second end. Further, a first portion of the upper beam overlaps a portion of the interior bar member; and a second portion of the upper beam overlaps a portion of the exterior bar member. Additionally, the interior bar member and the exterior bar member are welded to the upper beam.

In another embodiment of the support structure, one of the interior storage tank and the exterior storage tank includes a hydraulic fluid storage tank. In yet another embodiment, one of the interior storage tank and the exterior storage tank includes at least one of a fuel tank, a battery module, and a flywheel.

The present disclosure further provides a storage tank assembly for a mining truck, the storage tank assembly including a support structure pivotably coupled to a chassis of the mining truck; an interior storage tank supported by and pivotably coupled to the support structure; and an exterior storage tank supported by and pivotably coupled to the support structure. The interior storage tank is pivotable relative to the support structure independently of the exterior storage tank. The exterior storage tank is pivotable relative to the support structure independently of the interior storage tank. In another embodiment of the storage tank assembly, the interior storage tank is vibrationally isolated from the support structure. In yet another embodiment, the exterior storage tank is vibrationally isolated from the support structure.

In another embodiment, the storage tank assembly includes one or more vibration dampers between at least one of: the support structure and the chassis; the interior storage tank and the support structure; and the exterior storage tank and the support structure. In a different embodiment, the support structure includes a crossbar defining a pivot axis about which the support structure is configured to pivot, the crossbar received between a chassis mounting post of the chassis and a clamping member coupled to the chassis mounting post so that the crossbar is freely rotatable.

The present disclosure also provides a method of mounting a first storage tank and a second storage tank to a chassis of a mining truck. The method includes mounting a support structure to a mounting post of the chassis of the mining truck; mounting a pre-existing storage tank to a center mounting interface of the support structure; and mounting a second storage tank to an exterior mounting interface of the support structure so that the second storage tank is positioned adjacent to the pre-existing storage tank. In another embodiment, the support structure is pivotably mounted to the mounting post of the chassis by an interior mounting interface about a first pivot axis; the pre-existing storage tank is pivotable relative to the chassis about a second pivot axis; and the second storage tank is pivotable relative to the chassis about a third pivot axis. Further, the pre-existing storage tank is pivotable independently of the second storage tank and the second storage tank is pivotable independently of the pre-existing storage tank.

In another embodiment of the method, the pre-existing storage tank is cylindrical. In yet another embodiment, mounting the support structure includes receiving a crossbar of the support structure between the mounting post of the chassis and a clamping member so that the crossbar is freely rotatable. In a different embodiment, mounting the pre-existing storage tank includes receiving a portion of the pre-existing storage tank within a slot defined by a support tab of the support structure and coupling a clamping member to the support tab so that the portion of the pre-existing storage tank is positioned between the support tab and the clamping member.

While multiple embodiments are disclosed, still other embodiments of the present disclosure will become apparent to those skilled in the art from the following detailed description, which shows and describes illustrative embodiments of the disclosure. Accordingly, the drawings and detailed description are to be regarded as illustrative in nature and not restrictive.

### BRIEF DESCRIPTION OF THE DRAWINGS

The detailed description of the drawings particularly refers to the accompanying figures in which:

FIG. 1 is a schematic top-down illustration of an architecture arrangement of components of a mining truck, in accordance with embodiments of the present disclosure;

FIG. 2 is a perspective view illustration of an exemplary chassis and components mounted thereon, in accordance with embodiments of the present disclosure;

FIG. 3 illustrates a schematic top-down illustration of another architecture arrangement of components of a mining truck, in accordance with embodiments of the present disclosure;

FIG. 4 illustrates a schematic side view illustration of the architecture arrangement of FIG. 3, in accordance with embodiments of the present disclosure;

FIG. 5 illustrates a second schematic side view illustration of the architecture arrangement of FIG. 3, in accordance with embodiments of the present disclosure;

FIG. 6 illustrates a top-down schematic illustration of another architecture arrangement of components of a mining truck, in accordance with embodiments of the present disclosure;

FIG. 7A illustrates a storage tank assembly, in accordance with embodiments of the present disclosure;

FIG. 7B illustrates a plan view of the storage tank assembly of FIG. 7A, in accordance with embodiments of the present disclosure;

FIG. 8 illustrates a plan view of a support structure, in accordance with embodiments of the present disclosure;

FIG. 9A illustrates a storage tank mounted to a support structure, in accordance with embodiments of the present disclosure;

FIG. 9B illustrates an additional view of FIG. 9A, in accordance with embodiments of the present disclosure;

FIG. 10 illustrates an isometric view of a support structure, in accordance with embodiments of the present disclosure;

FIG. 11 illustrates a portion of a support structure, in accordance with embodiments of the present disclosure;

FIG. 12 illustrates a portion of a support structure, in accordance with embodiments of the present disclosure;

FIG. 13 illustrates a portion of a support structure, in accordance with embodiments of the present disclosure; and

FIG. 14 illustrates an exterior bar member of a support structure, in accordance with embodiments of the present disclosure.

Although the drawings represent embodiments of various features and components according to the present disclosure, the exemplification set out herein illustrates an embodiment, and such an exemplification is not to be construed as limiting the scope of the disclosure in any manner.

### DETAILED DESCRIPTION OF THE DRAWINGS

The present disclosure relates to architectures, or component arrangement, of hybrid mining trucks; more particular aspects relate to a mounting frame for a hybrid mining truck.

As noted above, in view of environmental and efficiency considerations, there are efforts to electrify and/or hybridize large equipment vehicles (e.g., mining trucks, cranes, bulldozers). The size and workload of such vehicles can present a variety of challenges to alternative powertrain configurations. In some instances, the work environment of such vehicles can include high temperatures and rugged terrain, which can challenge the durability of vehicle components, particularly with respect to vibration damage. Additionally, some design configurations, such as those including retrofitting an internal-combustion-powered mining truck for hybrid or electric-powered operation, can have a limited available space for installing and/or rearranging components.

To address these and other challenges, embodiments of the present disclosure include a chassis-mountable support structure for a mining truck. Embodiments of the present disclosure can provide additional storage capacity adjacent to an existing storage tank of a mining truck. Embodiments of the present disclosure can further obviate or minimize retrofit modifications to the storage tank and to the location of the storage tank on the mining truck. In this way, embodiments of the present disclosure can facilitate efficiently retrofitting an existing mining truck for increased storage capacity. In an example, embodiments of the present disclosure can provide additional storage capacity for an internal-combustion-powered mining truck being retrofitted for hybrid or electric-powered operation. Embodiments of the present disclosure can further provide a durable support structure that can have a relatively high strength-to-weight ratio. In an example, the support structure can be configured to vibrationally isolate an interior storage tank and an exterior storage tank from the chassis of the mining truck; vibrationally isolate the interior storage tank from the support structure; and vibrationally isolate the exterior storage tank from the support structure. In an additional example, the support structure can provide a beneficial strength-to-weight ratio by including bar portions and channel portions. Such embodiments can improve durability by reducing a likelihood of vibration damage to one or more components of the mining truck.

For the purposes of promoting an understanding of the principles of the present disclosure, reference will now be made to the embodiments illustrated in the drawings, which are described herein. The embodiments disclosed herein are not intended to be exhaustive or to limit the invention to the precise form disclosed. Rather, the embodiments are chosen and described so that others skilled in the art may utilize their teachings. Therefore, no limitation of the scope of the claimed invention is thereby intended. The present invention includes any alterations and further modifications of the illustrated devices and described methods and further applications of principles in the invention which would normally occur to one skilled in the art to which the invention relates.

The terms “couples,” “coupled,” “coupler,” and variations thereof are used to include both arrangements wherein the two or more components are in direct physical contact and arrangements wherein the two or more components are not in direct contact with each other (e.g., the components are “coupled” via at least a third component), but yet still cooperate or interact with each other.

In some instances throughout this disclosure and in the claims, numeric terminology, such as first, second, third, fourth, etc., is used in reference to various components of features. Such use is not intended to denote an ordering of the components or features. Rather, numeric terminology is used to assist the reader in identifying the components or features being referenced and should not be narrowly interpreted as providing a specific order of components or features.

While the disclosure herein is provided in terms of a “mining truck”, it is understood that the features described herein may apply to other vehicles, including heavy equipment such as cranes, bulldozers, excavators, etc., locomotives, and other appropriate vehicles.

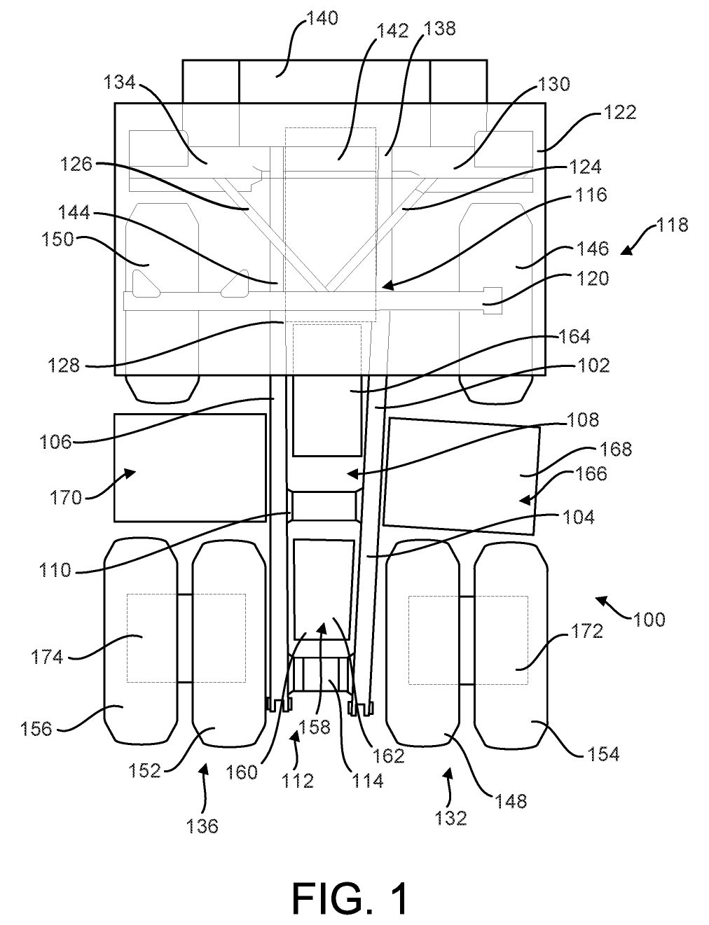

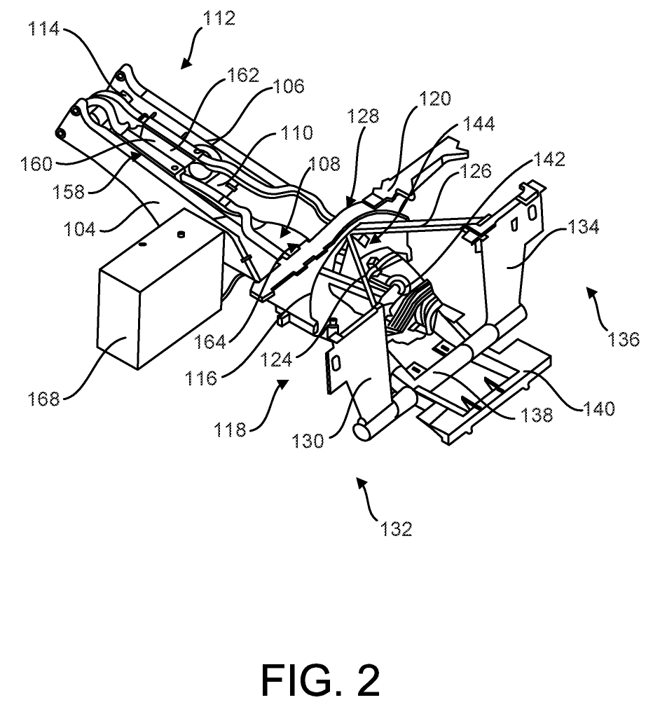

A schematic architecture of an exemplary mining truck 100 is illustrated in FIG. 1. As shown, mining truck 100 may be generally built on and/or around chassis 102. Referring additionally to FIG. 2, chassis 102 may include a first frame member 104 and a second frame member 106 extending longitudinally from a first end portion of the chassis, including a first end of the chassis, to a second end portion of the chassis, including a second end of the chassis, to at least partially define a length of mining truck 100. First frame member 104 and second frame member 106 may be spaced apart to form a space 108 therebetween, with a central crossbeam 110 extending from first frame member 104 to second frame member 106 across space 108, generally defining a rear chassis region 112. A rear crossbeam 114 extends from first frame member 104 to second frame member 106 across space 108 at the rear of chassis 102, and a horse collar 116 may connect first frame member 104 and second frame member 106 within a forward region 118 of chassis 102.

A third frame member 120 may extend across the top of horse collar 116 and beyond the diameter of horse collar 116 to form a support for a deck 122 (FIG. 1) as described further herein. A first supplemental frame member 124 and a second supplemental frame member 126 may each extend diagonally from a central portion 128 of third frame member 120 above horse collar 116. First supplemental frame member 124 and second supplemental frame member 126 may extend in opposite directions. First supplemental frame member 124 may connect to a first support plate 130, and second supplemental frame member 126 may connect to a second support plate 134. First support plate 130 may also connect to first frame member 104 on a first side 132 of chassis 102, and second support plate 134 may also connect to second frame member 106 on a second side 136 of chassis 102.

A forward crossbeam 138 may extend from first frame member 104 to second frame member 106 in general alignment with first support plate 130 and second support plate 134. A support extension 140 may extend forward of forward crossbeam 138. An engine 142 may be positioned within an opening 144 defined by horse collar 116. A traction alternator and/or gearbox may be mounted rearward of engine 142 within area 164.

Referring again to FIG. 1, wheels 146, 148, 150, and 152 may be mounted to chassis 102 via respective axles (not shown). For example, as shown, first wheel 146 may be mounted at a forward position in forward region 118 on first side 132 of chassis 102. Second wheel 148 may be mounted at a rearward position in rear chassis region 112 on first side 132 of chassis 102. Third wheel 150 may be mounted at a forward position in forward region 118 on second side 136 of chassis 102. Fourth wheel 152 may be mounted at a rearward position in rear chassis region 112 on second side 136 of chassis 102. In some embodiments, mining truck 100 may include a fifth wheel 154 mounted adjacent to second wheel 148 at a rearward position in rear chassis region 112 on first side 132 of chassis 102. Some embodiments may additionally include a sixth wheel 156 mounted adjacent to fourth wheel 152 at a rearward position in rear chassis region 112 on second side 136 of chassis 102. First wheel 146 and third wheel 150 may be mounted at a position generally corresponding to third frame member 120.

A rear region space 158 defined between first frame member 104 and second frame member 106 within rear chassis region 112, and at least partially defined between second wheel 148 and fourth wheel 152, may be sized and shaped to receive a vehicle subsystem 160. For example, as shown in FIG. 2, vehicle subsystem 160 may include an aftertreatment system 162. In other embodiments, vehicle subsystem 160 may include a battery module, a fuel tank, a powertrain support subsystem, an exhaust muffler, an exhaust silencer, or any other vehicle subsystems necessary or otherwise desired for operation of mining truck 100. As described herein, an exhaust muffler and an exhaust silencer may be similar or the same components intended to quiet an exhaust by some volume. In other embodiments, rear region space 158 may be free of any vehicle subsystems or components.

First wheel 146 and second wheel 148 may define a space, or first side saddle 166 therebetween. In some embodiments, as illustrated in FIGS. 1-2, a fuel tank 168 may be mounted to chassis 102 within first side saddle 166. Fuel tank 168 may contain, for example, diesel fuel or an alternative fuel, e.g., ammonia, methanol, ethanol, or other fuels suitable of operation of mining truck 100. Likewise, third wheel 150 and fourth wheel 152 may define a space, or second side saddle 170. A first wheel motor 172 may be associated with second wheel 148 and, in embodiments including a fifth wheel, fifth wheel 154. A second wheel motor 174 may be associated with fourth wheel 152 and, in embodiments including a sixth wheel, sixth wheel 156. In some embodiments including a fifth and/or sixth wheel, each of second wheel 148, fourth wheel 152, fifth wheel 154, and sixth wheel 156 may have a separate wheel motor. In other embodiments, all of wheels 146, 148, 150, 152, 154, and 156 or wheels 146, 148, 150, 152, or any combination thereof, may be associated with a wheel motor, whether such wheel motor is designated to a single wheel or such wheel motor is shared between two or more wheels.

Still referring to FIG. 1, deck 122 may be supported by chassis 102, and, for example, by third frame member 120, first support plate 130, and second support plate 134. In other words, deck 122 may be supported by the first end portion of chassis 102, wherein the first end of portion of chassis 102 includes a first end of chassis 102. Deck 122 may be configured to support a cab to facilitate operation of mining truck 100 and various vehicle subsystems, including hybrid powertrain subsystems and components as discussed further herein.

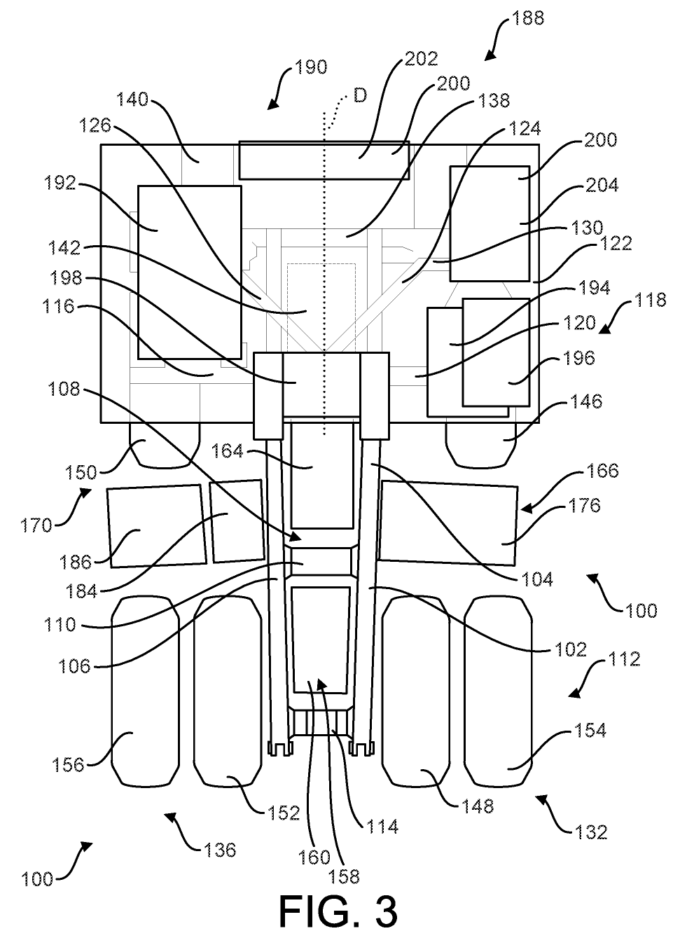

Now referring to FIGS. 3-5, a second exemplary architecture for mining truck 100 is illustrated. Mining truck 100 as illustrated in FIG. 3-5 includes the same components and details as described in relation to FIGS. 1 and/or 2 except as described further herein, with like components associated with like reference numbers.

As described above, mining truck 100 may include chassis 102 having first frame member 104 and second frame member 106. First wheel 146 may be mounted at a forward position in forward region 118 on first side 132 of chassis 102, i.e., adjacent to first frame member 104. Second wheel 148 may be mounted at a rearward position in rear chassis region 112 on first side 132 of chassis 102, i.e., adjacent to first frame member 104, and spaced apart from first wheel 146 to define first side saddle 166 therebetween. A battery pack module 176 may be mounted to first side 132 of chassis 102 within first side saddle 166.

Battery pack module 176 may be configured to store power for use in operation of mining truck 100. In hybrid applications, battery pack module 176 may cooperate with engine 142 to provide power to wheels 146, 148, 150, 152 and, in some embodiments, wheels 154, 156 for movement of mining truck 100. Battery pack module 176 may be mounted within first side saddle 166 at a position which mitigates potential contact of any one of wheels 146, 148, 150, 152, 154 (when present) and/or 156 (when present).

Mounting of battery pack module 176 within first side saddle 166 may facilitate an even balance of mining truck 100 when one or more tanks are also mounted to chassis 102 within second side saddle 170 as discussed further herein. This placement may also maximize space for battery positioning while allowing the batteries to be put in a single, unified space rather than distributed in several places over the architecture of mining truck 100. For example, in some embodiments, battery pack module 176 may include a plurality of battery pack layers in a vertical arrangement, where each battery pack layer of the plurality of battery pack layers includes one or more battery packs. This vertical arrangement of battery packs as positioned in a side saddle may take advantage of a height of mining truck 100 to include as many battery packs as necessary for efficient operation of mining truck 100 in a hybrid operation mode. While these benefits are acknowledged, it is also within the scope of this disclosure that battery pack module 176 and/or a plurality of battery packs may be alternately positioned, whether in a single, unified space (i.e., on deck 122, within rear region space 158, or another placement), or in a plurality of places throughout the architecture of mining truck 100.

Referring again to FIGS. 3-5, a hydraulic liquid tank 184 may be mounted to second side 136 of chassis 102 within second side saddle 170. Hydraulic liquid tank 184 may serve as a reservoir for containing excess hydraulic fluid for operation of mining truck 100 and/or serve to hold a supply of hydraulic fluid for operation of mining truck 100. A second liquid tank 186 is mounted to chassis 102 within second side saddle 170. In some embodiments, second liquid tank 186 may be a fuel tank.

As illustrated, hydraulic liquid tank 184 may be mounted to chassis 102 at an interior position of second side saddle 170, while second liquid tank 186 may be mounted to chassis 102 at an exterior position of second side saddle 170, so that hydraulic liquid tank 184 is substantially in-between the chassis and the second liquid tank 186. In other embodiments, hydraulic liquid tank 184 and second liquid tank 186 may be alternately arranged. For example, in some embodiments, second liquid tank 186 may be mounted to chassis 102 at an interior position of second side saddle 170, while hydraulic liquid tank 184 may be mounted to chassis 102 at an exterior position of second side saddle 170. In yet other embodiments, hydraulic liquid tank 184 and second liquid tank 186 may both be arranged at a generally interior position of second side saddle 170 so that one of hydraulic liquid tank 184 and second liquid tank 186 is positioned at a forward position near third wheel 150, and the other of the hydraulic liquid tank 184 and second liquid tank 186 is positioned at a rearward position near fourth wheel 152. In some embodiments, a third liquid tank, for example, a second fuel tank, may be mounted to the chassis 102 within the second side saddle 170. In other embodiments, the second fuel tank may be mounted to chassis 102 within the first side saddle 166 in place of or in tandem with battery pack module 176.

Although the embodiments described above include mounting of battery pack module 176 within first side saddle 166 with hydraulic liquid tank 184 and second liquid tank 186 mounted within second side saddle 170, other arrangements may be considered that also enjoy at least some of the advantages discussed above. For example, in some embodiments, battery pack module 176 may be mounted within second side saddle 170 adjacent to hydraulic liquid tank 184 while second liquid tank 186 is mounted to chassis 102 within first side saddle 166. In other embodiments, hydraulic liquid tank 184 may remain in second side saddle 170, second liquid tank 186 may be mounted to chassis 102 within first side saddle 166, and battery pack module 176 may be mounted to deck 122.

Rear region space 158 defined by chassis 102 between second wheel 148 and fourth wheel 152 may include a vehicle subsystem 160 mounted therein, such as an aftertreatment system, a heating system for a bed of mining truck 100, and/or an exhaust muffler. In some embodiments, rear region space 158 may remain empty of any vehicle subsystems. It is within the scope of the disclosure that other subsystems beyond those listed explicitly herein may be mounted within rear region space 158.

As discussed above, deck 122 may be supported at a forward position by chassis 102. Deck 122 may include a first region 188 associated with a first side of deck 122 corresponding with first side 132 of chassis 102 and a second region 190 associated with a second side of deck 122 corresponding with second side 136 of chassis 102. First region and second region are illustrated by dividing line “D”. An operator cab 192 may be arranged within second region 190 of deck 122. Operator cab 192 is configured to house an operator during operation of mining truck 100, along with controls necessary or desired for said operation of mining truck 100.

A resistor grid 194 may be arranged within first region 188 of deck 122 and may be positioned at a generally rearward position of first region 188 of deck 122. A DC/DC system 196 may be positioned on top of resistor grid 194 so that DC/DC system 196 and resistor grid 194 are in a vertically stacked arrangement. An inverter cabinet 198 may be positioned at least partially in first region 188 of deck 122 and at least partially in second region 190 of deck 122. For example, inverter cabinet 198 may be equally positioned in first region 188 and second region 190 or, in some embodiments, be positioned so that a majority of inverter cabinet 198 is in first region 188. In other embodiments, inverter cabinet 198 may be positioned so that a majority of inverter cabinet 198 is in second region 190. As illustrated, inverter cabinet 198 may be positioned at within a rear portion of deck 122. The positioning of inverter cabinet 198 in this manner may provide an open area for positioning of additional mining truck components, for example, as described further herein.

Still referring to FIGS. 3-5, mining truck 100 may further include a thermal management system 200. Thermal management system 200 may include a radiator 202 and a DC/DC-battery thermal manager 204. In some embodiments, radiator 202 and DC/DC-battery thermal manager 204 may be integrated, i.e., one thermal management component may serve as both radiator 202 and DC/DC-battery thermal manager 204. In other embodiments, radiator 202 may service both engine 142 and DC/DC system 196, while DC/DC-battery thermal manager 204 only services battery pack module 176.

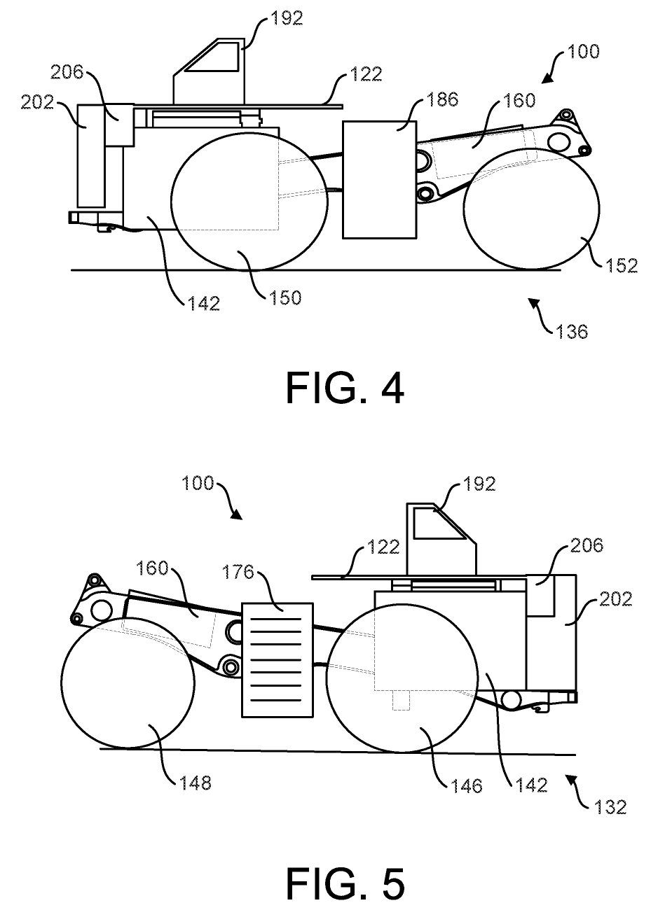

As illustrated, radiator 202 may be mounted to a front of mining truck 100, or, in other words, at a full forward position relative to deck 122. For example, radiator may be mounted at the first end portion of chassis 102 adjacent the first end of chassis 102. In some embodiments, radiator 202 may be, at least in part, mounted to a forward edge of deck 122 so that radiator 202 extends downward from deck 122. In other embodiments, radiator 202 may be mounted to a front of mining truck 100 below deck 122. In yet other embodiments, radiator 202 may be mounted at another position of mining truck 100. Referring specifically to FIGS. 4-5, an air cleaner 206 may be integrated with or positioned immediately adjacent to radiator 202 between radiator 202 and engine 142 to mitigate the presence of dirt, dust, and other contaminants within engine 142, mounted within horse collar 116 of chassis 102.

DC/DC-battery thermal manager 204 may be positioned on deck 122 within first region 188 at a forward position of resistor grid 194 and/or DC/DC system 196. DC/DC-battery thermal manager 204 is configured to be fluidly coupled to battery pack module 176 provide coolant or refrigerated liquid to battery pack module 176, and, in some embodiments, may be fluidly coupled to DC/DC/ system 196 to provide thermal management services to DC/DC system 196.

The arrangement of components on the deck as described herein are exemplary in nature and may be altered within the scope of the disclosure. For example, in some embodiments, first region 188 and second region 190 may be mirrored or switched. In other embodiments, components may be moved relative to one another and/or relative to deck 122. Positioning of the components of the deck as described herein may mitigate damage and/or poor performance from dust, dirt, mud, and/or other environmental considerations. Furthermore, placement of such components on deck 122 in combination with mounting of battery pack module 176, hydraulic liquid tank 184, and second liquid tank 186 in respective side saddles 166, 170 facilitates weight balance of mining truck 100. However, other placements are within the scope of the disclosure.

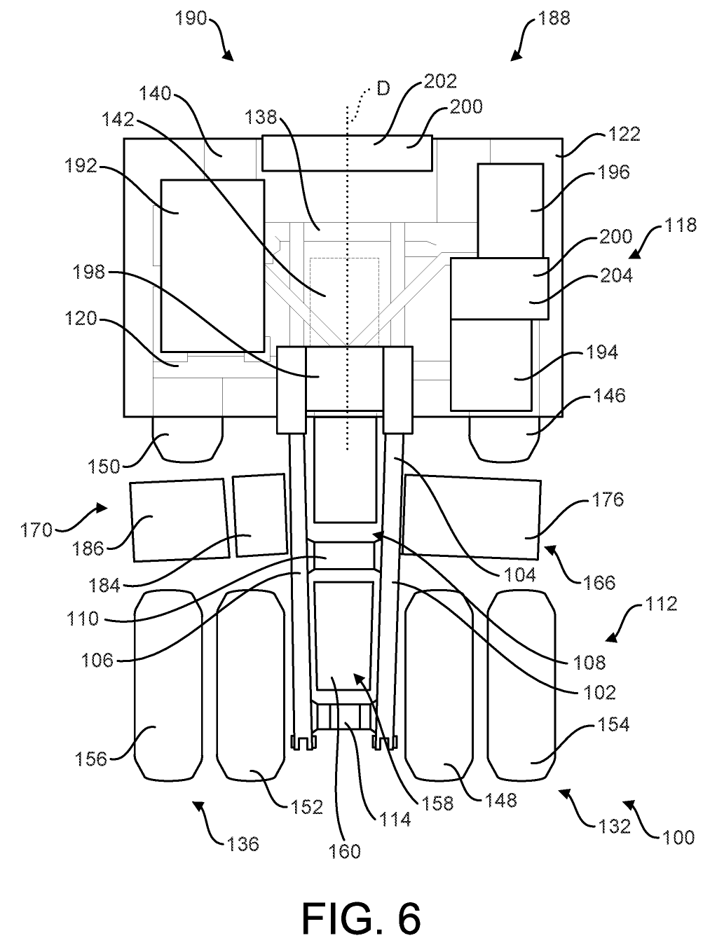

Now referring to FIG. 6, another exemplary architecture for mining truck 100 is illustrated. Mining truck 100 as illustrated in FIG. 6 includes the same components and details as described in relation to FIGS. 1-5 except as described further herein, with like components associated with like reference numbers.

Resistor grid 194 may be arranged within first region 188 of deck 122 and may be positioned at a generally rearward position of first region 188 of deck 122. DC/DC-battery thermal manager 204 may be positioned forward of resistor grid 194, with DC/DC system 196 positioned forward of DC/DC-battery thermal manager 204, so that DC/DC-battery thermal manager 204 is positioned generally between resistor grid 194 and DC/DC system 196. The positioning of the components herein provides access to service panels on top of resistor grid 194, while further accounting for positioning of DC/DC-battery thermal manager 204 in an efficient position relative to DC/DC system 196 and battery pack module 176 mounted within first side saddle 166. The arrangement of components as described in relation to FIG. 6 may also mitigate interference with line-of-sight to side mirrors (not shown) of mining truck 100 from operator cab 192 positioned within second region 190 of deck 122. The arrangement of components on the deck as described herein are exemplary in nature and may be altered within the scope of the disclosure. For example, in some embodiments, first region 188 and second region 190 may be mirrored or switched. In other embodiments, components may be moved relative to one another and/or relative to deck 122.

Positioning of the components of the deck as described herein may mitigate damage and/or poor performance from dust, dirt, mud, and/or other environmental considerations. Furthermore, placement of such components on deck 122 in combination with mounting of battery pack module 176, hydraulic liquid tank 184, and second liquid tank 186 in respective side saddles 166, 170 facilitates weight balance of mining truck 100. However, other placements are within the scope of the disclosure.

The arrangement of components on the deck as described herein are exemplary in nature and may be altered within the scope of the disclosure. For example, in some embodiments, first region 188 and second region 190 may be mirrored or switched. In other embodiments, components may be moved relative to one another and/or relative to deck 122.

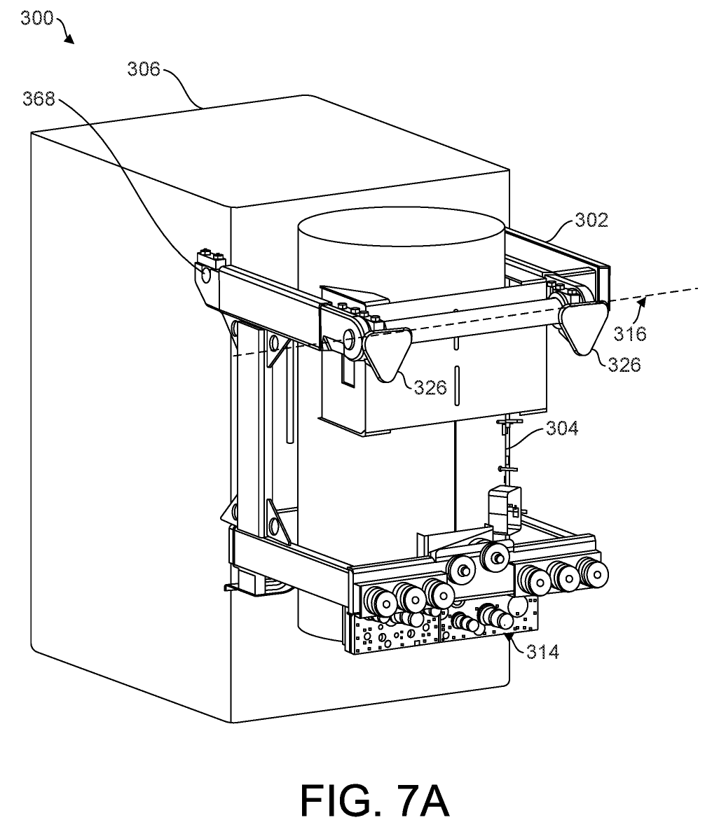

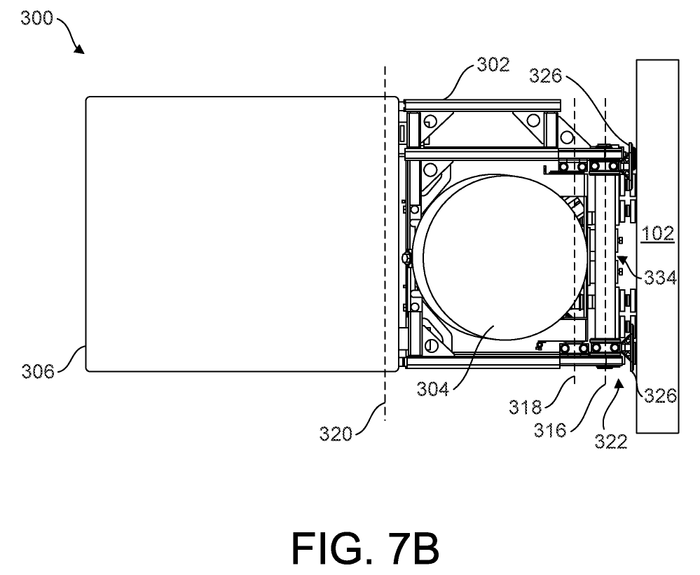

FIG. 7A shows an isometric view of the storage tank assembly 300 according to embodiments of the present disclosure. Storage tank assembly 300 may include support structure 302, interior storage tank 304, and exterior storage tank 306. In some embodiments, interior storage tank 304 may be identical or substantially similar to hydraulic liquid tank 184 (FIG. 3). In some embodiments, interior storage tank 304 may be a hydraulic liquid tank which is conventional in design. In other words, interior storage tank 304 may be a preexisting tank that is not required to be substantially changed in structure to be mounted to support structure 302 as described further herein. In such embodiments, for example, interior storage tank 304 may be cylindrical in shape. In other embodiments, interior storage tank 304 may be of a new design that is a cylindrical shape or an alternative shape, such as rectangular. Tank connections 314 provide an interface for fluid transfer between interior storage tank 304 and mining truck 100.

In some embodiments, exterior storage tank 306 may be identical or substantially similar to second liquid tank 186 (FIG. 3). Storage tank assembly 300 is supported by mounting posts 326. While FIG. 7A illustrates storage tank assembly 300 having exterior storage tank 306 (e.g., a fuel tank), in some embodiments, exterior storage tank 306 may be replaced with an alternate energy storage system, such as a battery or a flywheel. In some embodiments, storage tank assembly 300 may facilitate mounting of exterior storage tank 306 relative to mining truck 100 at a position in which exterior storage tank 306 was not capable of previously being mounted. Exterior storage tank 306 may, in some embodiments, be a tank of conventional design that is not required to be substantially changed in structure to be mounted to support structure 302 as described further herein. In other embodiments, exterior storage tank 306 may be new in design.

Furthermore, while the tanks described herein are described as “interior storage tank” and “exterior storage tank” in reference to their relative positions to chassis 102, it is understood that, in some embodiments, the position of each storage tank to chassis 102 may be altered. For example, in some embodiments, each of interior storage tank 304 and exterior storage tank 306 may be positioned adjacent to chassis 102 with one of interior storage tank 304 and exterior storage tank 306 being positioned at a forward position of chassis 102 relative to the other storage tank and the other of interior storage tank 304 and exterior storage tank 306 being positioned at a rearward position of chassis relative to the other storage tank.

FIG. 7B shows a top view of storage tank assembly 300 of FIG. 7A. As shown, support structure 302 may support interior storage tank 304 adjacent to chassis 102 of mining truck 100 (FIG. 3) and between chassis 102 and exterior storage tank 306. Additionally, support structure 302 may support exterior storage tank 306 adjacent to interior storage tank 304.

Support structure 302 may attach to chassis 102 via interior mounting interface 322. For example, pivot member 334 of interior mounting interface 322 may be configured to be positioned onto chassis mounting posts 326 in a mounted configuration of support structure 302. Mounting posts 326 may be configured to be attached (e.g., welded, cast, molded, adhered, bolted, or otherwise coupled or bonded to) to chassis 102. In some embodiments, storage tank assembly 300 may be mounted to chassis 102 within second side saddle 170 (FIG. 3).

FIG. 7B further shows interior pivot axis 316, about which storage tank assembly 300 may pivot relative to chassis 102; center pivot axis 318, about which interior storage tank 304 may pivot relative to support structure 302; and exterior pivot axis 320, about which exterior storage tank 306 may pivot relative to support structure 302. As described further herein, interior storage tank 304 may pivot relative to support structure 302 independently of exterior storage tank 306, and exterior storage tank 306 may pivot relative to support structure 302 independently of interior storage tank 304. In some embodiments, interior storage tank 304 may be configured to be positioned directly onto chassis mounting posts 326. Such embodiments may or may not include exterior storage tank 306 mounted adjacent to interior storage tank 304.

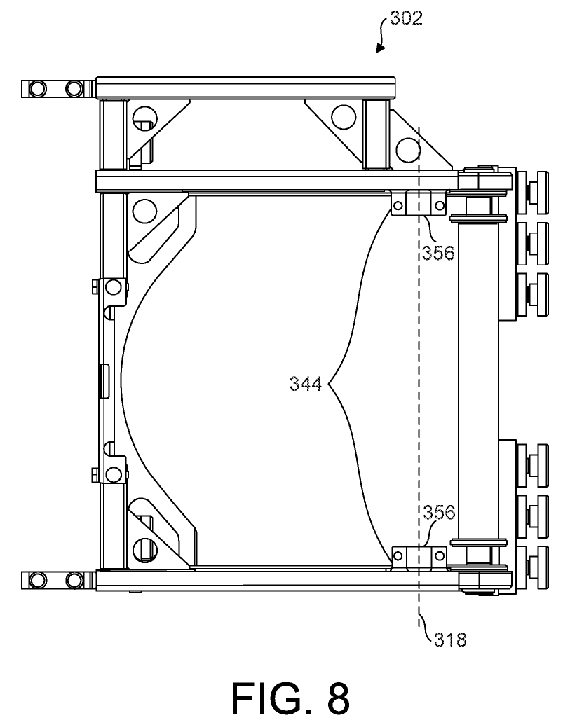

In other embodiments, as illustrated in FIG. 8, support structure 302 may include support tabs 344 and slots 356 to define center pivot axis 318. In other words, center pivot axis 318 may pass through a center of each of the support tabs 344, which may be designed to mimic the structure and function of chassis mounting posts 326, such that interior storage tank 304 may be positioned onto support tabs 344 in a manner similar to the manner with which interior storage tank 304 may be positioned onto chassis mounting posts 326. Additionally, pivot member 334 may be designed to mimic the structure and function of mounting portions of interior storage tank 304, such that support structure 302 may be positioned onto chassis mounting posts 326 in a manner similar to the manner with which interior storage tank 304 may be positioned onto chassis mounting posts 326.

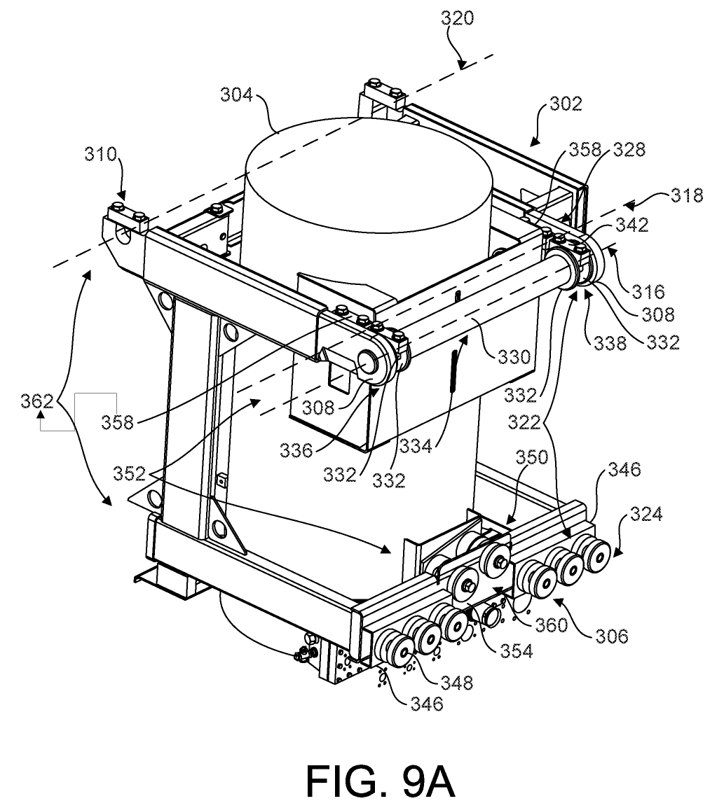

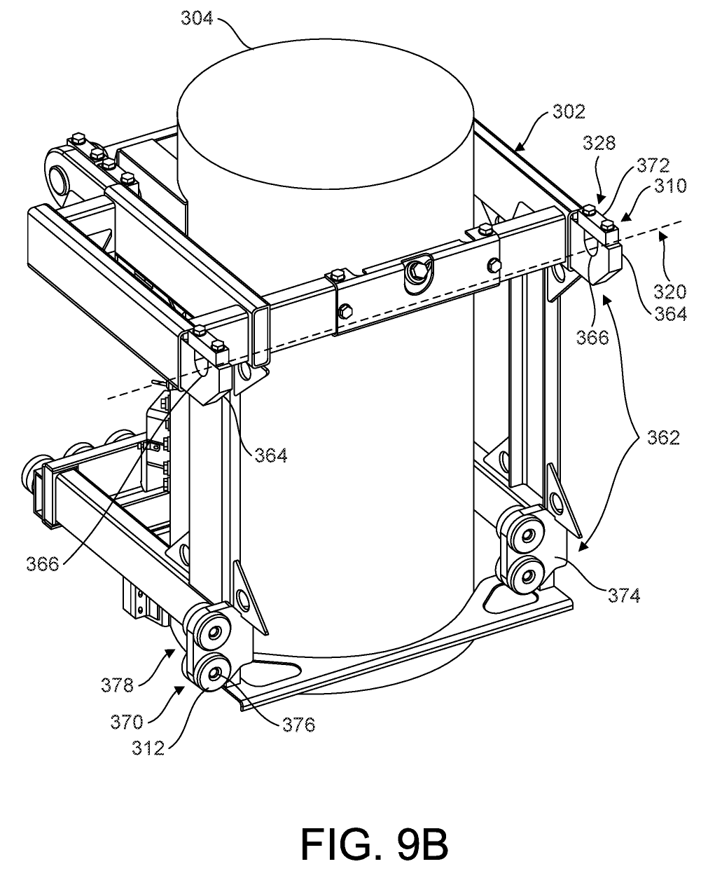

FIG. 9A shows an isometric view of interior storage tank 304 mounted to support structure 302. Support structure 302 may include interior mounting interface 322 configured to removably attach support structure 302 to chassis 102 (FIG. 7B). Interior mounting interface 322 may facilitate vibrational isolation of both interior storage tank 304 and exterior storage tank 306 from chassis 102 of mining truck 100. For example, interior mounting interface 322 may include pivot member 334 and interior damping portion 324. Pivot member 334 permits the assembly of support structure 302, interior storage tank 304, and/or exterior storage tank 306 (FIG. 7A) to pivot about interior pivot axis 316 relative to chassis 102 (FIG. 7B).

Additionally, interior damping portion 324 may prevent or reduce a transmission of vibration between chassis 102 (FIG. 7B) and support structure 302. By this combination of pivoting structure and damping structure, interior mounting interface 322 may provide vibrational isolation and thereby improve the durability of support structure 302. In an example, such vibrational isolation may reduce one or more loads on welds and joints of support structure 302. Similarly, as discussed below, in some embodiments, center mounting interface 352 may be configured to permit pivoting and damped motion of interior storage tank 304 relative to support structure 302. In some embodiments, exterior mounting interface 362 may be configured to permit pivoting and damped motion of exterior storage tank 306 relative to support structure 302. Such embodiments may additionally reduce one or more loads on welds and joints of support structure 302. In some embodiments, the pivoting structure discussed above may provide vibrational isolation without including dampers (i.e., damping portion 324) due to the ability of each of interior storage tank 304 and exterior storage tank 306 to pivot relative to chassis 102 and/or support structure 302 independently of each other as described further herein.

Pivot member 334 of interior mounting interface 322 may include crossbar 330 having interior pivot axis 316 so that support structure 302 is pivotable about interior pivot axis 316 relative to chassis 102. Pivot member 334 may further include a pair of interior bar members 308 attached to crossbar 330 so that one interior bar member 308 is positioned at each of a proximal side 336 and a distal side 338 of crossbar 330. Crossbar 330 may include a set of flanges 332 at each of a proximal side 336 and a distal side 338 of crossbar 330.

In mounting pivot member 334 to chassis 102, crossbar 330 may be positioned onto chassis mounting posts 326 (FIG. 7A) such that a chassis mounting post 326 (FIG. 7A) fits between flanges 332 at the proximal side 336 of crossbar 330, and a chassis mounting post 326 fits between flanges 332 at the distal side 338 of crossbar 330. Interior clamping members 342 may attach to chassis mounting posts 326 via fasteners 328 at each of the proximal side 336 and the distal side 338 of crossbar 330. Accordingly, in a mounted configuration of support structure 302, portions of crossbar 330 between flanges 332 may be sandwiched between interior clamping members 342 and chassis mounting posts 326. Thus, in the mounted configuration of support structure 302, interior clamping members 342, chassis mounting posts 326, and flanges 332 may restrict translational motion of support structure 302 relative to chassis 102. Additionally, in the mounted configuration of support structure 302, interior clamping members 342, chassis mounting posts 326, and flanges 332 may permit rotational motion (e.g., pivoting) of support structure 302 relative to chassis 102.

Interior damping portion 324 of interior mounting interface 322 may, in some embodiments, include damping brackets 346 to which interior vibration dampers 307 may be mounted. Interior vibration dampers 307 may prevent or reduce a transmission of vibration between chassis 102 and support structure 302. In some embodiments, interior vibration dampers 307 may include materials such as rubber, polyurethane, nitrile, nylon, silicone, ethylene propylene diene monomer (“EPDM”), and/or polyvinyl chloride. In some embodiments, in a mounted configuration of support structure 302, interior vibration dampers 307 may be positioned in pairs, such that a plate of the chassis 102 may be sandwiched between a pair of vibration dampers. In this way, interior vibration dampers 307 may absorb vibration energy in response to support structure 302 moving toward chassis 102 and/or in response to support structure 302 moving away from chassis 102. In some embodiments, interior vibration dampers 307 may include a mounting hole 348 through which a fastener (e.g., a bolt) may be inserted to removably attach support structure 302 and interior vibration dampers 307 to chassis 102.

Referring again briefly to FIG. 8, center mounting interface 352 may be configured to removably attach interior storage tank 304 to support structure 302. Center mounting interface 352 may include support tabs 344 and, in some embodiments, center damping portion 350. Support tabs 344 may include slots 356 defining center pivot axis 318 so that center pivot axis 318 passes through slots 356. Interior storage tank 304 may be positioned onto support tabs 344 such that mounting portions (not shown) of interior storage tank 304 are inserted into slots 356 so that interior storage tank 304 is supported and configured to pivot about center pivot axis 318 relative to support structure 302.

Referring again to FIG. 9A, center clamping members 358 may attach to support tabs 344 via fasteners 328. Accordingly, in a mounted configuration of interior storage tank 304, mounting portions of interior storage tank 304 may be sandwiched between support tabs 344 and center clamping members 358. Thus, in the mounted configuration of interior storage tank 304, interior bar members 308, support tabs 344 of interior bar members 308, and center clamping members 358 may restrict translational motion of interior storage tank 304 relative to support structure 302. Additionally, in the mounted configuration of interior storage tank 304, interior bar members 308, support tabs 344 of interior bar members 308, and center clamping members 358 may permit rotational motion (e.g., pivoting) of interior storage tank 304 relative to support structure 302.

In some embodiments, center damping portion 350 may include center damping plate 354 and center vibration dampers 360 that may be mounted to center damping plate 354. Center vibration dampers 360 may prevent or reduce a transmission of vibration between interior storage tank 304 and support structure 302. In some embodiments, center vibration dampers 360 may be the same or substantially similar to interior vibration dampers 307. In some embodiments, in a mounted configuration of interior storage tank 304, center vibration dampers 360 may be positioned in pairs, such that center damping plate 354 may be sandwiched between a pair of center vibration dampers 360. In this way, center vibration dampers 360 may absorb vibration energy in response to interior storage tank 304 moving toward center damping plate 354 and/or in response to interior storage tank 304 moving away from center damping plate 354. In some embodiments, center vibration dampers 360 may include a mounting hole through which a fastener (e.g., a bolt) may be inserted to removably attach interior storage tank 304 and center vibration dampers 360 to center damping plate 354 of support structure 302. As discussed above and further herein, some embodiments may not include center damping portion 350 and/or center damping plate 354 and/or center vibration dampers 360.

FIG. 9B shows an additional isometric view of interior storage tank 304 and support structure 302 of FIG. 9A. As shown, exterior mounting interface 362 may be configured to removably attach exterior storage tank 306 (FIG. 7B) to support structure 302 adjacent to interior storage tank 304. Exterior mounting interface 362 may include exterior bar members 364 and lower interface 370.

Exterior bar members 364 may include slot portions 366 defining an exterior pivot axis 320 passing through slot portions 366. Exterior storage tank 306 may be positioned onto exterior bar members 364 such that mounting tabs 368 (FIG. 7A) of exterior storage tank 306 fit into slot portions 366. In this way, slot portions 366 may support exterior storage tank 306 such that exterior storage tank 306 may pivot about exterior pivot axis 320 relative to support structure 302.

Exterior clamping members 372 (FIG. 9B) may attach to exterior bar members 364 via fasteners 328. Accordingly, in a mounted configuration of exterior storage tank 306, mounting tabs 368 of exterior storage tank 306 may be sandwiched between exterior bar members 364 and exterior clamping members 372. Thus, in the mounted configuration of exterior storage tank 306, exterior bar members 364 and exterior clamping members 372 may restrict translational motion of exterior storage tank 306 relative to support structure 302. Additionally, in the mounted configuration of exterior storage tank 306, exterior bar members 364 and exterior clamping members 372 may permit rotational motion (e.g., pivoting) of exterior storage tank 306 relative to support structure 302.

Lower interface 370 may be configured to contact and removably attach to a lower portion of exterior storage tank 306 (FIG. 7A). For example, lower interface 370 may include one or more contact plates 374 and/or one or more exterior vibration dampers 312, the assembly of such components forming an exterior damping portion 378. In such embodiments, exterior vibration dampers 312 may prevent or reduce a transmission of vibration between exterior storage tank 306 and support structure 302. In some embodiments, exterior vibration dampers 312 may be the same or substantially similar to interior vibration dampers 307. In some embodiments, contact plates 374 and/or exterior vibration dampers 312 may include an exterior mounting hole 376 through which a fastener (e.g., a bolt) may be inserted to removably attach exterior storage tank 306 and, in some instances, exterior vibration dampers 312, to contact plates 374 of support structure 302. In some embodiments, exterior storage tank 306 may be removably attached to contact plates 374 without vibration dampers 307.

For example, the mounting of the exterior storage tank 306 to support structure 302 as described herein may facilitate transmission of load to a primary damping system at the interface between mining truck 100 and storage tank assembly 300, helping to balance some of the load at the interface between storage tank 306 and support structure 302. Such relationship and transfer of load may mitigate or eliminate the need for additional structures, e.g., vibration damper(s), being included with support structure 302.

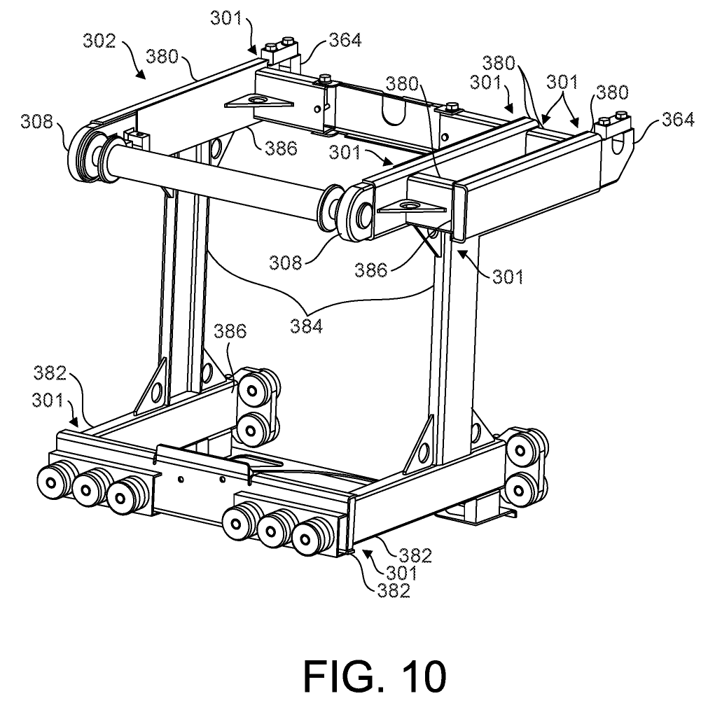

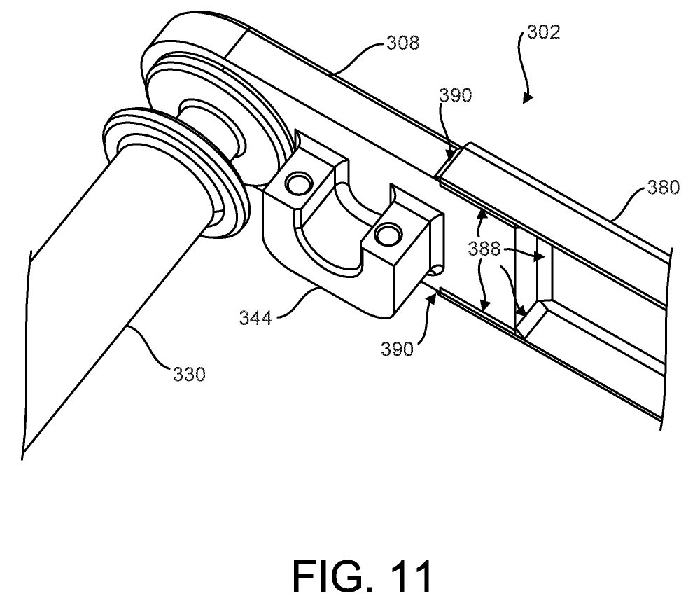

As discussed above, embodiments of the present disclosure may provide durability and a high strength-to-weight ratio. For example, FIG. 10 shows support structure 302 having a plurality of upper beams 380 and lower beams 382 attached by middle beams 384. FIG. 10 additionally shows a plurality of joints 301 where upper beams 380 may be attached to one another and lower beams 382 may be attached to one another. In some embodiments, such beams may be formed from a channel (e.g., steel C-channel), permitting such beams to have a reduced weight relative to beams having a rectangular cross section (e.g., steel bar). Such embodiments may further include stiffening plates and portions formed of bar material to increase strength and durability. For example, support structure 302 may include a plurality of stiffening plates 386 and bar-material portions (e.g., interior bar members 308 and exterior bar members 364). Such bar-material portions may be attached to upper beams 380 and/or lower beams 382 by inside and outside welds, as exemplified in the discussion of FIG. 11 below.

Referring to FIG. 11, crossbar 330, interior bar member 308 having support tab 344, and upper beam 380 in the form of a C-channel is illustrated. By including interior bar member 308 attached to (e.g., welded to) crossbar 330, support structure 302 may provide an assembly having increased strength relative to an assembly in which upper beam 380 is attached directly to crossbar 330. Additionally, as shown in FIG. 11, a portion of upper beam 380 may overlap a portion of interior bar member 308. By this configuration, a plurality of inside welds 388 and a plurality of outside welds 390 may be formed to attach interior bar member to 308 upper beam 380. By including inside welds 388 and outside welds 390, the shown configuration may provide increased binding strength between interior bar member 308 and upper beam 380 relative to a configuration in which only outside welds 390 were used to bind those components. Such increased binding strength may improve the durability of support structure 302 by reducing a likelihood of weld failure.

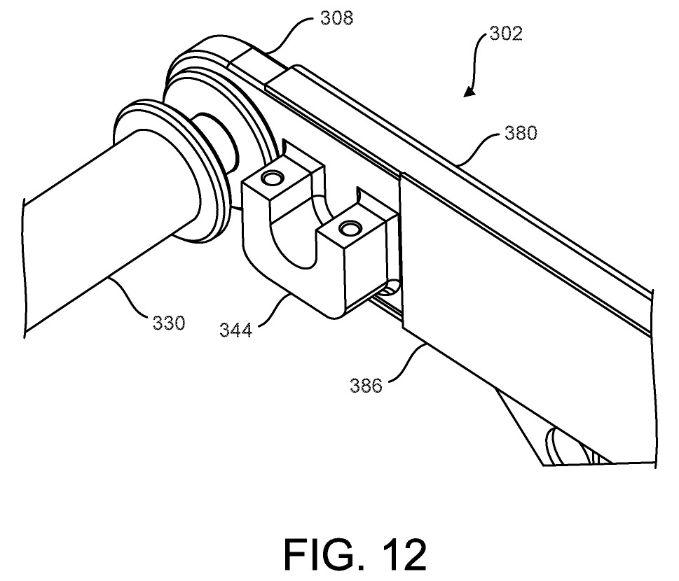

The configuration of inside welds 388 and outside welds 390 discussed with respect to FIG. 11 may be applied in an identical or substantially similar manner to attach other bar-member portions (e.g., exterior bar members 364, FIG. 10) to upper beams 380 (FIG. 10). As discussed with respect to FIG. 12 below, embodiments of the present disclosure may further include one or more stiffening plates 386 (FIG. 10).

Referring to FIG. 12, crossbar 330, interior bar member 308 having support tab 344, upper beam 380 in the form of a C-channel, and stiffening plate 386 are illustrated, according to embodiments of the present disclosure. This configuration permits the use of inside welds 388 and outside welds 390 as discussed with respect to FIG. 11. This configuration may additionally include stiffening plate 386 that may be attached (e.g., welded) to upper beam 380 such that stiffening plate 386 overlaps and covers one or more inside welds. Embodiments of the present disclosure including stiffening plate 386 may provide additional durability by increasing the stiffness of upper beam 380. As shown in FIG. 10, such stiffening plates may be applied in a plurality of positions on support structure 302.

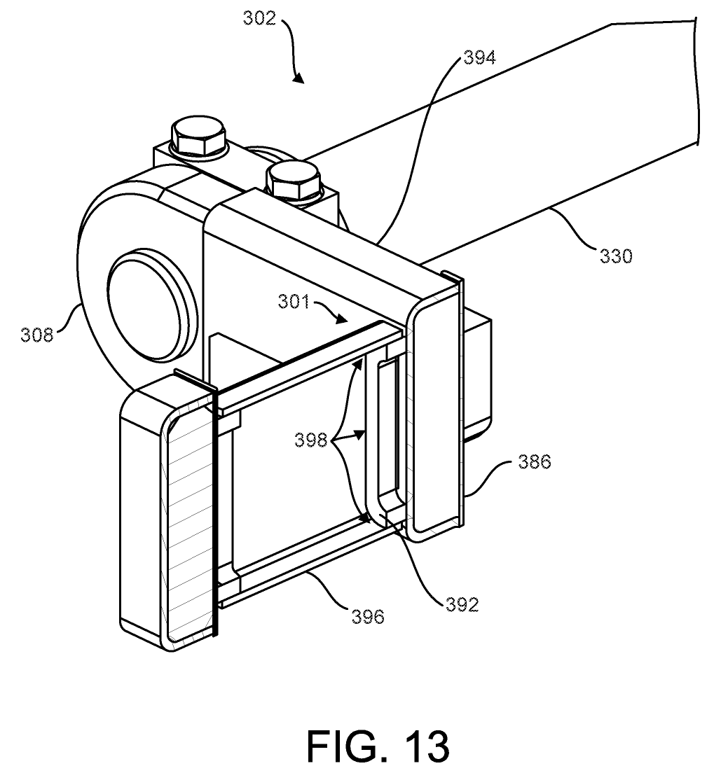

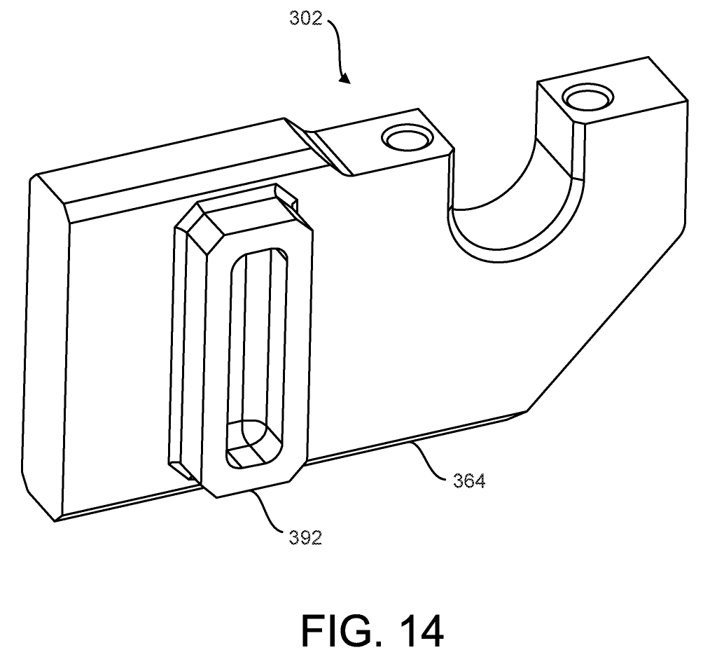

FIGS. 13 and 14 show an additional strengthening feature according to embodiments of the present disclosure. For example, FIG. 13, illustrates a configuration of interior bar member 308, first upper beam 394, second upper beam 396, stiffening plate 386, and crossbar 330. As shown, a portion of first upper beam 394 may overlap a portion of interior bar member 308 in a manner similar to that discussed with respect to FIG. 11. Additionally, interior bar member 308 may further includes a joint tab 392. Joint tab 392 is a protrusion (e.g., a boss) sized to fit within a channel (e.g., second upper beam 396). Joint tab 392 may provide a plurality of areas 398 for incorporation with inside welds for bonding components together (e.g., for bonding interior bar member 308 to second upper beam 396). By this configuration, embodiments of the present disclosure may provide additional strength at joints (e.g., joint 301) of support structure 302.

Now referring to FIG. 14, exterior bar member 364 may include a joint tab 392 as discussed with respect to FIG. 13. Such joint tabs 392 may be formed on one or more bar members (e.g., exterior bar member 364) of support structure 302 to facilitate incorporation of inside welds at joints 301 of support structure 302. Thus, embodiments of the present disclosure may provide increased strength at joints 301 of support structure 302 and thereby improve the durability of support structure 302.

Various modifications and additions may be made to the exemplary embodiments discussed without departing from the scope of the disclosed subject matter. For example, while the embodiments described above refer to particular features, the scope of this disclosure also includes embodiments having different combinations of features and embodiments that do not include all of the described features. Accordingly, the scope of the disclosed subject matter is intended to embrace all such alternatives, modifications, and variations as fall within the scope of the claims, together with all equivalents thereof.

Aspect 1 is a support structure for a mining truck, the support structure comprising: an interior mounting interface configured to removably attach the support structure to a chassis of the mining truck; a center mounting interface configured to support an interior storage tank adjacent to the chassis; and an exterior mounting interface configured to support an exterior storage tank adjacent to the interior storage tank.

Aspect 2 is the support structure of Aspect 1, wherein: the interior mounting interface comprises an interior pivot axis about which the support structure is pivotable relative to the chassis; the center mounting interface comprises a center pivot axis about which the interior storage tank is pivotable relative to the support structure; and the exterior mounting interface comprises an exterior pivot axis about which the exterior storage tank is pivotable relative to the support structure.

Aspect 3 is the support structure of Aspect 2, wherein each of the interior mounting interface, the center mounting interface, and the exterior mounting interface is pivotable independently of each other.

Aspect 4 is the support structure of Aspect 1, wherein each of the interior mounting interface, the center mounting interface, and the exterior mounting interface includes a damping portion having one or more vibration dampers.

Aspect 5 is the support structure of Aspect 1, further comprising an upper beam extending between the interior mounting interface and the exterior mounting interface, wherein: the upper beam comprises a channel having a first end and a second end; the interior mounting interface comprises an interior bar member attached to the first end; and the exterior mounting interface comprises an exterior bar member attached to the second end.

Aspect 6 is the support structure of Aspect 5, wherein: a first portion of the upper beam overlaps a portion of the interior bar member; and a second portion of the upper beam overlaps a portion of the exterior bar member.

Aspect 7 is the support structure of Aspect 5, wherein the interior bar member and the exterior bar member are welded to the upper beam.

Aspect 8 is the support structure of Aspect 1, wherein one of the interior storage tank and the exterior storage tank comprises a hydraulic fluid storage tank.

Aspect 9 is the support structure of Aspect 1, wherein one of the interior storage tank and the exterior storage tank comprises at least one of a fuel tank, a battery module, and a flywheel.

Aspect 10 is a storage tank assembly for a mining truck, the storage tank assembly comprising: a support structure pivotably coupled to a chassis of the mining truck; an interior storage tank supported by and pivotably coupled to the support structure; and an exterior storage tank supported by and pivotably coupled to the support structure; wherein the interior storage tank is pivotable relative to the support structure independently of the exterior storage tank; and wherein the exterior storage tank is pivotable relative to the support structure independently of the interior storage tank.

Aspect 11 is the storage tank assembly of Aspect 10, wherein the interior storage tank is vibrationally isolated from the support structure.

Aspect 12 is the storage tank assembly of Aspect 10, wherein the exterior storage tank is vibrationally isolated from the support structure.

Aspect 13 is the storage tank assembly of Aspect 10, further comprising one or more vibration dampers between at least one of: the support structure and the chassis; the interior storage tank and the support structure; and the exterior storage tank and the support structure.

Aspect 14 is the storage tank assembly of Aspect 10, wherein the support structure includes a crossbar defining a pivot axis about which the support structure is configured to pivot, the crossbar received between a chassis mounting post of the chassis and a clamping member coupled to the chassis mounting post so that the crossbar is freely rotatable.

Aspect 15 is a method of mounting a first storage tank and a second storage tank to a chassis of a mining truck, comprising: mounting a support structure to a mounting post of the chassis of the mining truck; mounting a pre-existing storage tank to a center mounting interface of the support structure; and mounting a second storage tank to an exterior mounting interface of the support structure so that the second storage tank is positioned adjacent to the pre-existing storage tank.

Aspect 16 is the method of Aspect 15, wherein the support structure is pivotably mounted to the mounting post of the chassis by an interior mounting interface about a first pivot axis; the pre-existing storage tank is pivotable relative to the chassis about a second pivot axis; and the second storage tank is pivotable relative to the chassis about a third pivot axis.

Aspect 17 is the method of Aspect 16, wherein the pre-existing storage tank is pivotable independently of the second storage tank and the second storage tank is pivotable independently of the pre-existing storage tank.

Aspect 18 is the method of Aspect 15, wherein the pre-existing storage tank is cylindrical.

Aspect 19 is the method of Aspect 15, wherein mounting the support structure includes receiving a crossbar of the support structure between the mounting post of the chassis and a clamping member so that the crossbar is freely rotatable.

Aspect 20 is the method of Aspect 15, wherein mounting the pre-existing storage tank includes receiving a portion of the pre-existing storage tank within a slot defined by a support tab of the support structure and coupling a clamping member to the support tab so that the portion of the pre-existing storage tank is positioned between the support tab and the clamping member.

We claim:

1. A support structure for a mining truck, the support structure comprising:
an interior mounting interface configured to removably attach the support structure to a chassis of the mining truck;
a center mounting interface configured to support an interior storage tank adjacent to the chassis; and
an exterior mounting interface configured to support an exterior storage tank adjacent to the interior storage tank.

2. The support structure of claim 1, wherein:
the interior mounting interface comprises an interior pivot axis about which the support structure is pivotable relative to the chassis;
the center mounting interface comprises a center pivot axis about which the interior storage tank is pivotable relative to the support structure; and
the exterior mounting interface comprises an exterior pivot axis about which the exterior storage tank is pivotable relative to the support structure.

3. The support structure of claim 2, wherein each of the interior mounting interface, the center mounting interface, and the exterior mounting interface is pivotable
independently of each other.

4. The support structure of claim 1, wherein each of the interior mounting interface, the center mounting interface, and the exterior mounting interface includes a
damping portion having one or more vibration dampers.

5. The support structure of claim 1, further comprising an upper beam extending between the interior mounting interface and the exterior mounting interface,
wherein:
the upper beam comprises a channel having a first end and a second end;
the interior mounting interface comprises an interior bar member attached to the first end; and
the exterior mounting interface comprises an exterior bar member attached to the second end.

6. The support structure of claim 5, wherein:
a first portion of the upper beam overlaps a portion of the interior bar member; and
a second portion of the upper beam overlaps a portion of the exterior bar member.

7. The support structure of claim 5, wherein the interior bar member and the exterior bar member are welded to the upper beam.

8. The support structure of claim 1, wherein one of the interior storage tank and the exterior storage tank comprises a hydraulic fluid storage tank.

9. The support structure of claim 1, wherein one of the interior storage tank and the exterior storage tank comprises at least one of a fuel tank, a battery module,
and a flywheel.

10. A storage tank assembly for a mining truck, the storage tank assembly comprising:
a support structure pivotably coupled to a chassis of the mining truck;
an interior storage tank supported by and pivotably coupled to the support structure; and
an exterior storage tank supported by and pivotably coupled to the support structure;
wherein the interior storage tank is pivotable relative to the support structure independently of the exterior storage tank; and
wherein the exterior storage tank is pivotable relative to the support structure independently of the interior storage tank.

11. The storage tank assembly of claim 10, wherein the interior storage tank is vibrationally isolated from the support structure.

12. The storage tank assembly of claim 10, wherein the exterior storage tank is vibrationally isolated from the support structure.

13. The storage tank assembly of claim 10, further comprising one or more vibration dampers between at least one of:
the support structure and the chassis;
the interior storage tank and the support structure; and
the exterior storage tank and the support structure.

14. The storage tank assembly of claim 10, wherein the support structure includes a crossbar defining a pivot axis about which the support structure is configured to
pivot, the crossbar received between a chassis mounting post of the chassis and a clamping member coupled to the chassis mounting post so that the crossbar is
freely rotatable.

15. A method of mounting a first storage tank and a second storage tank to a chassis of a mining truck, comprising:
mounting a support structure to a mounting post of the chassis of the mining truck;
mounting a pre-existing storage tank to a center mounting interface of the support structure; and
mounting a second storage tank to an exterior mounting interface of the support structure so that the second storage tank is positioned adjacent to the pre
existing storage tank.

16. The method of claim 15, wherein:
the support structure is pivotably mounted to the mounting post of the chassis by an interior mounting interface about a first pivot axis;
the pre-existing storage tank is pivotable relative to the chassis about a second pivot axis; and
the second storage tank is pivotable relative to the chassis about a third pivot axis.

17. The method of claim 16, wherein the pre-existing storage tank is pivotable independently of the second storage tank and the second storage tank is pivotable
independently of the pre-existing storage tank.

18. The method of claim 15, wherein the pre-existing storage tank is cylindrical.

19. The method of claim 15, wherein mounting the support structure includes receiving a crossbar of the support structure between the mounting post of the chassis
and a clamping member so that the crossbar is freely rotatable.

20. The method of claim 15, wherein mounting the pre-existing storage tank includes receiving a portion of the pre-existing storage tank within a slot defined by a
support tab of the support structure and coupling a clamping member to the support tab so that the portion of the pre-existing storage tank is positioned between
the support tab and the clamping member.
